(19) United States
(12) Patent Application Publication
(10) Pub. No.: US 2008/0096989 A1
(43) Pub. Date: Apr. 24, 2008

(54) Flame Retardant Expanded Polystyrene Foam Compositions

(75) Inventors: Kimberly A. Maxwell, Baton Rouge, LA (US); William J. Layman JR., Baton Rouge, LA (US)

Correspondence Address: EDGAR SPIELMAN;ALBEMARLE CORPORATION, 451 FLORIDA BLVD., BATON ROUGE, LA, 70801, US

(73) Assignee: ALBEMARLE CORPORATION, Baton Rouge, LA (US)

(21) Appl. No.: 11/722,446

(22) PCT Filed: Dec. 22, 2004
(86) PCT No.: PCT/US04/43332

§ 371 Date: Jun. 21, 2007

(51) Int. Cl. C08J 9/16; C08J 9/00; C08L 25/06

(52) U.S. Cl. 521/56; 521/143

(57) ABSTRACT

Expandable polystyrene foam compositions having flame retardant properties, flame retardant expanded polystyrene foams, methods of making such foams, and products comprising such compositions and foams are provided. A flame-retarded expanded polystyrene foam contains a flame retardant compound having the structure (I).

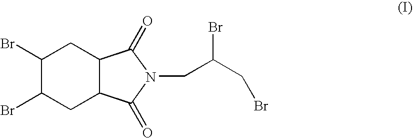

### FIELD OF THE INVENTION

The present invention relates to flame retardant compositions and expanded polystyrene foams formed therefrom.

### BACKGROUND OF THE INVENTION

Styrenic polymer compositions and foams, such as expandable polystyrene foam, are used widely in the manufacture of molded articles, paints, films coatings, and miscellaneous products. Expandable styrenic polymers, such as expanded polystyrene, typically are made by suspension polymerization of a mixture of styrene monomer(s) and flame retardant in water to form beads of styrenic polymer. The small beads (e.g., averaging about 1 mm in diameter) are pre-expanded with steam and molded again with steam to produce large blocks (e.g., up to several meters high and 2-3 meters wide) that are cut in the desired dimensions.

For some product applications, it may be desirable to decrease the flammability of such compositions and foams. Flame retardants for use in expanded polystyrene foams have many requirements including thermal stability, substantial solubility in styrene, and high flame retardancy.

Halogenated flame retardant compounds have been proposed for use in various polymers. See, for example, U.S. Pat. Nos. 3,784,509; 3,868,388; 3,903,109; 3,915,930; and 3,953,397, each of which is incorporated by reference in its entirety. However, some flame retardant compositions are not sufficiently soluble in styrene and can adversely impact the formation and quality of the polystyrene foam. Possible suspension failure can occur if insoluble particles act as nucleating sites, leading to a sudden viscosity increase of the styrene/water mixture and rapid formation of a large mass of polystyrene in the reactor.

Thus, there is a need for a flame retardant compound for use in expanded polystyrene foam that is sufficiently soluble in styrene so it will not interfere with the formation of the foam.

### SUMMARY OF THE INVENTION

The present invention is directed generally to a flame-retarded expanded polystyrene foam. According to one aspect of the invention, the expanded polystyrene foam contains a flame retardant compound having the structure: 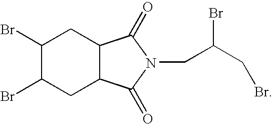
The flame retardant compound may be present in an amount of from about 0.1 to about 10 wt % of the foam. In one aspect, the flame retardant compound is present in an amount of from about 0.5 to about 7 wt % of the foam. In another aspect, the flame retardant compound is present in an amount of from about 0.7 to about 5 wt % of the foam. In yet another aspect, the flame retardant compound is present in an amount of from about 1 to about 2 wt % of the foam.

The flame retardant may have a solubility in styrene at about 25° C. of from about 0.5% to about 8%. In one aspect, the flame retardant has a solubility in styrene at about 40° C. of from about 0.5 wt % to about 10 wt %.

The expanded polystyrene foam may be used to form an article of manufacture. For example, the expanded polystyrene foam may be used to form thermal insulation.

The present invention also contemplates a flame-retarded expanded polystyrene foam containing a flame retardant compound having a solubility in styrene at 25° C. of from about 0.5 wt % to about 8 wt %.

According to another aspect of the present invention, a composition containing from about 0.5 wt % to about 8 wt % of a flame retardant compound solubilized in styrene is provided, where the compound is:

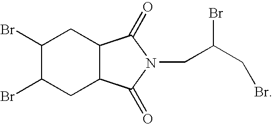

The present invention further contemplates a method of producing flame retardant expanded polystyrene foam. The method comprises forming a composition comprising a flame retardant compound solubilized in styrene and a blowing agent, wherein the flame retardant compound has a solubility in styrene at 25° C. of from about 0.5 wt % to about 8 wt % and has the structure: 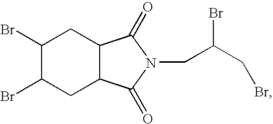
polymerizing the styrene to form polystyrene beads.

The present invention still further contemplates a process for making a molded flame retardant expanded polystyrene product. The process comprises pre-expanding unexpanded beads comprising polystyrene, a blowing agent, and a flame retardant compound having the structure: 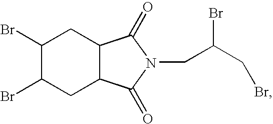
wherein the beads are substantially free of antimony trioxide, and molding the pre-expanded beads and, optionally, further expanding the beads, to form the product. The product may be thermal insulation.

### DETAILED DESCRIPTION OF THE INVENTION

The present invention is directed generally to expandable polystyrene foam compositions having flame retardant properties, flame retardant expanded polystyrene foams, methods of making such foams, and products comprising such compositions and foams. According to one aspect of the present invention, a flame retardant expandable polystyrene foam composition comprises a styrenic polymer, for example, polystyrene, and at least one flame retardant compound. Optionally, the composition may include one or more synergists, stabilizers, or various other additives.

The flame retardant compounds of the present invention are compounds having the structure:

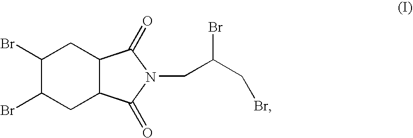

### N,2-3-Dibromopropyl-4,5-dibromohexahydrophthalimde CAS. No. 93202-89-2

its tautomeric forms, stereoisomers, and polymorphs (collectively referred to as “compound (I)”).

It has been discovered that use of compound (I) to form a flame retardant composition results in a thermally stable and efficacious expanded polystyrene foam. Unlike other compounds that interfere with foam formation, compound (I) is sufficiently soluble in styrene that it does not adversely affect formation of the polystyrene foam.

The flame retardant compound has a solubility in styrene at about 25° C. of from about 0.5 to about 8 weight (wt) %. In one aspect, the flame retardant compound has a solubility in styrene at about 25° C. of from about 3 to about 7 wt %. In another aspect, the flame retardant compound has a solubility in styrene at about 25° C. of from about 4 to about 6 wt %.

Further, the flame retardant compound has a solubility in styrene at about 40° C. of from about 0.5 to about 10 wt %. In one aspect, the flame retardant has a solubility in styrene at about 40° C. of from about 4 to about 8 wt %. In another aspect, the flame retardant has a solubility in styrene at about 40° C. of from about 6 to about 8 wt %.

The flame retardant compound is typically present in the composition in an amount of from about 0.1 to about 10 wt % of the composition. In one aspect, the flame retardant compound is present in an amount of from about 0.3 to about 8 wt % of the composition. In another aspect, the flame retardant compound is present in an amount of from about 0.5 to about 7 wt % of the composition. In yet another aspect, the flame retardant compound is present in an amount of from about 0.7 to about 5 wt % of the composition. In still another aspect, the flame retardant compound is present in an amount of from about 1 to about 2 wt % of the composition. While various exemplary ranges are provided herein, it should be understood that the exact amount of the flame retardant compound used depends on the degree of flame retardancy desired, the specific polymer used, and the end use of the resulting product.

The expanded foam of the present invention is formed from a vinyl aromatic monomer having the formula:
H₂C═CR—Ar;
wherein R is hydrogen or an alkyl group having from 1 to 4 carbon atoms and Ar is an aromatic group (including various alkyl and halo-ring-substituted aromatic units) having from about 6 to about 10 carbon atoms, for example. A styrenic monomer. Examples of such monomers include, but are not limited to, styrene, alpha-methylstyrene, ortho-methylstyrene, meta-methylstyrene, para-methylstyrene, para-ethylstyrene, isopropenyltoluene, isopropenylnaphthalene, vinyl toluene, vinyl naphthalene, vinyl biphenyl, vinyl anthracene, the dimethylstyrenes, t-butylstyrene, the several chlorostyrenes (such as the mono- and dichloro-variants), and the several bromostyrenes (such as the mono-, dibromo- and tribromo-variants).

According to one aspect of the present invention, the monomer is styrene. Polystyrene is prepared readily by bulk or mass, solution, suspension, or emulsion polymerization techniques known in the art. Polymerization can be effected in the presence of free radical, cationic or anionic initiators, such as di-t-butyl peroxide, azo-bis(isobutyronitrile), di-benzoyl peroxide, t-butyl perbenzoate, dicumyl peroxide, potassium persulfate, aluminum trichloride, boron trifluoride, etherate complexes, titanium tetrachloride, n-butyllithium, t-butyllithium, cumylpotassium, 1,3-trilithiocyclohexane, and the like. Additional details of the polymerization of styrene, alone or in the presence of one or more monomers copolymerizable with styrene, are well known and are not described in detail herein.

The polystyrene typically has a molecular weight of at least about 1,000. According to one aspect of the present invention, the polystyrene has a molecular weight of at least about 50,000. According to another aspect of the present invention, the polystyrene has a molecular weight of from about 150,000 to about 500,000. However, it should be understood that polystyrene having a greater molecular weight may be used where suitable or desired.

The flame retardant composition of the present invention optionally may include a synergist. The synergist generally may be present in an amount of from about 0.01 to about 5 wt % of the composition. In one aspect, the synergist is present in an amount of from about 0.05 to about 3 wt % of the composition. In another aspect, the synergist is present in an amount of from about 0.1 to about 1 wt % of the composition. In yet another aspect, the synergist is present in an amount of from about 0.1 to about 0.5 wt % of the composition. In still another aspect, the synergist is present in an amount of about 0.2 wt % of the composition.

Where a synergist is used, the ratio of the total amount of synergist to the total amount of flame retardant compound typically is from about 1:1 to about 1:7. According to one aspect of the present invention, the ratio of the total amount of synergist to the total amount of flame retardant compound is from about 1:2 to about 1:4. Examples of synergists that may be suitable for use with the present invention include, but are not limited to, dicumyl, ferric oxide, zinc oxide, zinc borate, and oxides of a Group V element, for example, bismuth, arsenic, phosphorus, and antimony. According to one aspect of the present invention, the synergist is dicumyl peroxide.

However, while the use of a synergist is described herein, it should be understood that no synergist is required to achieve an efficacious flame retardant composition. Thus, according to one aspect of the present invention, the flame retardant composition is substantially free of a synergist. According to yet another aspect of the present invention, the flame retardant composition is substantially free of antimony compounds. According to another aspect of the present invention, the composition includes a synergist, but is substantially free of antimony trioxide.

The flame retardant foam of the present invention optionally includes a thermal stabilizer. Examples of thermal stabilizers include, but are not limited to zeolites; hydrotalcite; talc; organotin stabilizers, for example, butyl tin, octyl tin, and methyl tin mercaptides, butyl tin carboxylate, octyl tin maleate, dibutyl tin maleate; epoxy derivatives; polymeric acrylic binders; metal oxides, for example, ZnO, CaO, and MgO; mixed metal stabilizers, for example, zinc, calcium/zinc, magnesium/zinc, barium/zinc, and barium/calcium/zinc stabilizers; metal carboxylates, for example, zinc, calcium, barium stearates or other long chain carboxylates; metal phosphates, for example, sodium, calcium, magnesium, or zinc; or any combination thereof.

The thermal stabilizer generally may be present in an amount of from about 0.01 to about 10 wt % of the flame retardant compound. In one aspect, the thermal stabilizer is present in an amount of from about 0.3 to about 10 wt % of the flame retardant compound. In another aspect, the thermal stabilizer is present in an amount of from about 0.5 to about 5 wt % of the flame retardant compound. In yet another aspect, the thermal stabilizer is present in an amount of from about 1 to about 5 wt % of the flame retardant compound. In still another aspect, the thermal stabilizer is present in an amount of about 2 wt % of the flame retardant compound.

Other additives that may be used in the composition and foam of the present invention include, for example, extrusion aids (e.g., barium stearate or calcium stearate), organoperoxides or dicumyl compounds and derivatives, dyes, pigments, fillers, thermal stabilizers, antioxidants, antistatic agents, reinforcing agents, metal scavengers or deactivators, impact modifiers, processing aids, mold release agents, lubricants, anti-blocking agents, other flame retardants, other thermal stabilizers, antioxidants, UV stabilizers, plasticizers, flow aids, and similar materials. If desired, nucleating agents (e.g., talc, calcium silicate, or indigo) can be included in the polystyrene composition to control cell size.

The flame retardant composition of the present invention may be used to form flame retarded polystyrene foams, for example, expandable polystyrene foams. Such foams can be used for numerous purposes including, but not limited to, thermal insulation. Flame retardant polystyrene foams can be prepared by any suitable process known in the art. In general, the process comprises either a “one step process” or a “two step process”.

The more commonly used “one step process” comprises dissolution of the flame retardant in styrene, followed by an aqueous suspension polymerization carried out in two stages. The polymerization is run for several hours at about 90° C., where an initiator such as dibenzoyl peroxide catalyzes the polymerization, followed by a ramp up to about 130° C., during which a blowing agent is added under high pressure. At that temperature, dicumyl peroxide will complete the polymerization. The less commonly used “two step process” comprises addition of the flame retardant at a later stage, along with the blowing agent during the ramp up to about 130° C. Usually pentane soluble flame retardants are used in the “two step process”.

Additional examples of processes that may be suitable for use with the present invention include, but are not limited to, processes provided in U.S. Pat. Nos. 2,681,321; 2,744,291; 2,779,062; 2,787,809; 2,950,261; 3,013,894; 3,086,885; 3,501,426; 3,663,466; 3,673,126; 3,793,242; 3,973,884; 4,459,373; 4,563,481; 4,990,539; 5,100,923; and 5,124,365, each of which is incorporated by reference herein in its entirety. Procedures for converting expandable beads of styrenic polymers to foamed shapes are described, for example, in U.S. Pat. Nos. 3,674,387; 3,736,082; and 3,767,744, each of which is incorporated by reference herein in its entirety.

Various foaming agents or blowing agents can be used in producing the expanded or foamed flame retardant polymers of the present invention. Examples of suitable materials are provided in U.S. Pat. No. 3,960,792, incorporated by reference herein in its entirety. Volatile carbon-containing chemical substances are used widely for this purpose including, for example, aliphatic hydrocarbons including ethane, ethylene, propane, propylene, butane, butylene, isobutane, pentane, neopentane, isopentane, hexane, heptane, and any mixture thereof; volatile halocarbons and/or halohydrocarbons, such as methyl chloride, chlorofluoromethane, bromochlorodifluoromethane, 1,1,1-trifluoroethane, 1,1,1,2-tetrafluoroethane, dichlorofluoromethane, dichlorodifluoromethane, chlorotrifluoromethane, trichlorofluoromethane, sym-tetrachlorodifluoroethane, 1,2,2-trichloro-1,1,2-trifluoroethane, sym-dichlorotetrafluoroethane; volatile tetraalkylsilanes, such as tetramethylsilane, ethyltrimethylsilane, isopropyltrimethylsilane, and n-propyltrimethylsilane, and any mixture thereof. One example of a fluorine-containing blowing agent is 1,1-difluoroethane, provided under the trade name HFC-152a (FORMACEL Z-2, E.I. dupont de Nemours and Co.). Water-containing vegetable matter such as finely divided corncob can also be used as a blowing agent. As described in U.S. Pat. No. 4,559,367, incorporated by reference herein in its entirety such vegetable matter can also serve as a filler. Carbon dioxide also may be used as a blowing agent, or as a component thereof. Methods of using carbon dioxide as a blowing agent are described, for example, in U.S. Pat. Nos. 5,006,566; 5,189,071; 5,189,072; and 5,380,767, each of which is incorporated by reference herein in its entirety. Other examples of blowing agents and blowing agent mixtures include nitrogen, argon, or water with or without carbon dioxide. If desired, such blowing agents or blowing agent mixtures can be mixed with alcohols, hydrocarbons, or ethers of suitable volatility. See for example, U.S. Pat. No. 6,420,442, incorporated by reference herein in its entirety.

The expanded polystyrene foam typically may include the various components and additives in the relative amounts set forth above in connection with the compositions used to form the foam. Thus, for example, an expanded polystyrene foam according to the present invention may contain a flame retardant compound in an amount of from about 0.1 to about 10 wt % of the foam. In one aspect, the flame retardant compound is present in an amount of from about 0.3 to about 8 wt % of the foam. In another aspect, the flame retardant compound is present in an amount of from about 0.5 to about 7 wt % of the foam. In yet another aspect, the flame retardant compound is present in an amount of from about 0.7 to about 5 wt % of the foam. In still another aspect, the flame retardant compound is present in an amount of about from about 1 to about 2 wt % of the foam. While certain ranges and amounts are described herein, it should be understood that other relative amounts of the components in the foam are contemplated by the present invention.

The process for forming an expanded polystyrene foam product, for example, thermal insulation, is as follows. The raw material resin used to manufacture the expanded polystyrene foam is received in the form of small beads ranging from 0.5 to 1.3 mm in diameter. The small beads are formulated and manufactured by the suppliers to contain a small percentage of a blowing agent. The blowing agent is impregnated throughout the body of each small bead. The pre-expansion phase of manufacturing is simply the swelling of the small bead to almost 50 times its original size through the heating and rapid release of the gas from the bead during its glass transition phase.

A pre-determined quantity of beads is introduced into the expansion equipment. Steam is introduced into the vessel and an agitator mixes the expanding beads as the heat in the steam causes the pentane to be released from the beads. A level indicator indicates when the desired specified volume has been reached. After a pressure equalization phase, the expanded beads are released into a bed dryer and all condensed steam moisture is dried from the surface. The pre-expansion is complete and another cycle is ready to run. This process takes approximately 200 seconds to finish.

After the expanded beads have been dried, they are blown into large open storage bags for the aging process. The beads have been under a dynamic physical transformation that has left them with an internal vacuum in the millions of cells created. This vacuum must be equalized to atmospheric pressure; otherwise this delicate balance may result in the collapse, or implosion, of the bead. This process of aging the expanded beads allows the beads to fill back up with air and equalize. This aging can take from 12 hours to 48 hours, depending on the desired expanded density of the bead. After the aging is finished, the beads are then ready for molding into blocks.

The molding process involves taking the loose expanded beads and forming them into a solid block mass using, vacuum assisted, block mold. By utilizing a system of load cells, the computer is capable of controlling the exact weight of beads introduced into the mold cavity. Once the cavity is filled, the computer uses a vacuum system to evacuate residual air from the cavity. The vacuum is relieved by live steam, which flows over the entire mass of beads in the cavity. This vacuum rinsing process softens the polymer structure of the bead surface and is immediately followed by the pressurization of the mold cavity with more live steam. The latent heat from the steam and subsequent pressure increase cause the beads to expand further. Since this is a confined environment, the only way the beads can expand is to fill up any voids between them causing the soft surfaces to fuse together into a polyhedral type solid structure. The computer releases the pressure after it reaches its predetermined set point. The loose beads are now fused into a solid block.

Heat curing is the next step in the process. It accelerates the curing process of the freshly molded blocks, and assures that the material is dimensionally stable and provides a completely dry material for best fabrication results.

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may be suggested to one of ordinary skill in the art without departing from the spirit of the present invention or the scope of the appended claims.

### EXAMPLE 1

N,2-3-dibromopropyl-4,5-dibromohexahydrophthalimde (“compound (I)”) was prepared according to the following exemplary procedure. Other procedures are known in the art and are not discussed herein.

A 4-neck 5 L jacketed flask fitted with nitrogen flow and a water-cooled reflux condenser was charged with 900 g xylenes and 1 kg (6.57 mol) of tetrahydrophthalic anhydride (THPA, 95-96%). To the stirred (250 rpm) slurry, allylamine (413 g, 7.23 mol) was added over 45 min via an addition funnel. The reaction was exothermic and the temperature was maintained at 50 to 80° C. by use of a circulating bath fluid set to 30° C. After the allylamine addition was complete, the bath temperature was increased to 165° C., and held for 2 hours (reaction complete by GC). The circulating bath fluid temperature was reduced to 150° C., and solvent was removed using a vacuum aspirator (˜3″ Hg; Rxn T=138-140° C.). After removal of most of the xylenes, the bath temperature was reduced to 65° C. (Rxn T=56° C.), and 500 g of BCM (bromochloromethane) was added prior to washing with a base wash. A water solution (1,260 g water, 50 g Na₂CO₃) was added and stirred followed by phase separation. The dark red/brown organic phase (1,907 g: ˜500 g BCM, ˜1,256 g product (65.8 wt %), ˜200 g xylenes) was separated from the orange aqueous phase (1,332 g). GC analysis showed ˜100 area % product after caustic workup.

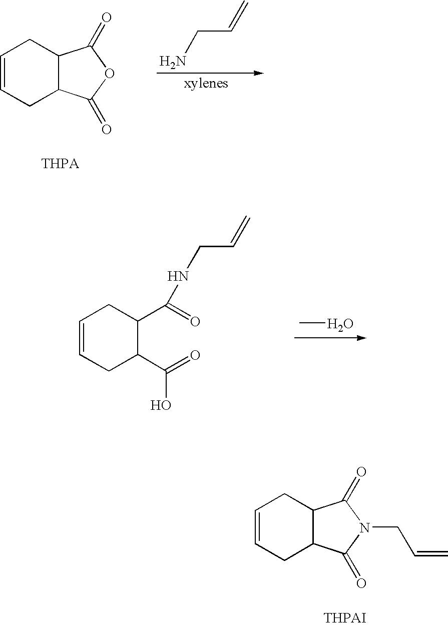

N-allyl-tetrahydrophthalimide:

| Reagent | FW | Mass, g | Mol | eq |
|---|---|---|---|---|
| Xylenes | | 900 | | |
| THPA | 152.15 | 1,000 | 6.57 | 1 |
| Allylamine | 57.10 | 413 | 7.23 | 1.1 |
| BCM | | 500 | | |
| THPAI | 191.23 | 1,200 | | |

A 4-neck 5 L jacketed flask fitted with nitrogen flow was charged with about 500 g BCM, about 20 g aqueous HBr, about 20 g ethanol, and the circulating bath temperature was cooled to about 2 to 3° C. (reaction T=5° C. initially). To the stirred (300 rpm) solvents were co-fed, above surface, from opposite ends of the flask via addition funnels, for about 2.5 hours, a solution of about 2,209 g (13.8 mol, 2.1-2.2 eq) of bromine, and the BCM/xylenes solution of THPAI (1,907 g). The reaction temperature remained below 33° C. The solution was stirred for another 30 min and an aqueous solution of water (1450 g), Na₂SO₃ (20 g, 0.16 mol, FW=126), Na₂CO₃ (90 g, 0.85 mol, FW=106) were added to wash the organic phase (aqueous phase pH=8-9). Methanol (1.7 kg) was added to the reactor at 45° C., and the reaction temperature was increased to about 50° C. (bath T about 68° C.). Another 1 kg of methanol was added as the reactor cooled to room temperature. The powder was filtered, rinsed with methanol, and dried at about 65° C. in an air-circulating oven for about 2.5 hours to yield 2,625 g of white powder product (76% yield) Mp 104-118° C.

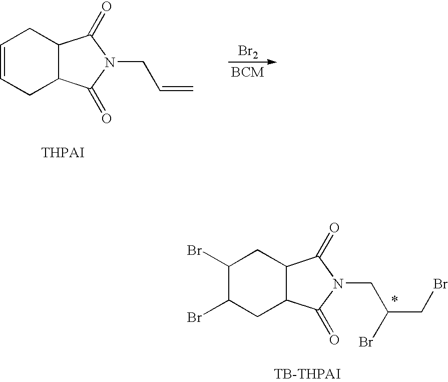

Brominated N-allyl-tetrahydrophthalimide (62.6 wt % Br):

| Reagent | FW | Mass, g | Mol | eq |
|---|---|---|---|---|
| xylenes | | ˜200 | | |
| BCM | | 1,000 | | |
| EtOH | | 20 | | |
| HBr (aq) | | 20 | | |
| THPAI soln | 191.23 | ˜1250 | 6.54 | 1.0 |
| Br₂ | 159.82 | 2209 | 13.8 | 2.1-2.2 |
| MeOH | | 2,700 | | |
| TB-THPAI | 510.85 | 2,625 | | |

### EXAMPLE 2

To illustrate flame retardant efficacy, various compositions containing N,2-3-dibromopropyl-4,5-dibromohexahydrophthalimde (“compound (I)”) were prepared and subjected to ASTM Standard Test Method D 2863-87, commonly referred to as the limiting oxygen index (LOI) test. In this test, the higher the LOI value, the more flame resistant the composition.

Sample A was prepared by making a concentrate (10 wt % compound I), and then letting the concentrate down into a neat resin at a ratio of about 35 wt % concentrate to about 65 wt % PS-168 neat resin and extruding low density foam via carbon dioxide injection. PS-168 is a general-purpose non-flame retarded grade of unreinforced crystal polystyrene commercially available from Dow Chemical Company. It has a weight average molecular weight of about 172,000 daltons and a number average molecular weight of about 110,000 daltons (measured by GPC). The molecular weight analyses were determined in THF with a Waters 150-CV modular gel permeation chromatograph equipped with a differential refractometer and a Precision Detectors model PD-2000 light scattering intensity detector and Ultrastyragel columns of 100, 103, 104, and 500 angstrom porosities. Polystyrene standards (Showa denko) were used in the determination of molecular weights.

The concentrate contained about 10 wt % compound I, about 0.5 wt % hydrotalcite thermal stabilizer, about 4.3 wt % Mistron Vapor Talc, about 1.5 wt % calcium stearate, and about 83.7 wt % Dow PS-168. The concentrates were produced on a Werner & Phleiderer ZSK-30 co-rotating twin screw extruder at a melt temperature of about 175° C. A standard dispersive mixing screw profile was used at about 250 rpm and a feed rate of about 1 kg/hour. PS-168 resin concentrates were fed via a single screw gravimetric feeder, and the powder additives were pre-mixed and fed using a twin screw powder feeder.

The concentrate was then mixed into neat Dow polystyrene PS-168 using the same twin screw extruder at a ratio of about 35 weight % concentrate to about 65 weight % polystyrene to produce foam using the following conditions: temperatures of Zones 1 (about 175° C.), 2 (about 160° C.), 3 (about 130° C.), and 4 (about 130° C.), about 145° C. die temperature, about 60 rpm screw speed, about 3.2 kg/hour feed rate, 40/80/150 screen pack, from about 290 to about 310 psig carbon dioxide pressure, about 160° C. melt temperature, from about 63 to about 70% torque, and from about 2 to about 3 ft/minute takeoff speed.

The foam contained about 3.5 wt % flame retardant (about 2.2 wt % bromine), and about 1.5 wt % talc as a nucleating agent for the foaming process. DHT4A hydrotalcite in an amount of about 5 wt % of the flame retardant compound was also used to stabilize the flame retardant during the extrusion and foam-forming process. A standard two-hole stranding die (⅛ inch diameter holes) was used to produce the foams, with one hole plugged. The resulting ⅝ inch diameter foam rods had a very thin surface skin (0.005 inches or less) and a fine closed cell structure. Carbon dioxide gas was injected into barrel #8 (the ZSK-30 is a 9-barrel extruder). The rods were foamed with carbon dioxide to a density of about 9.0 lbs/ft³ (0.14 specific gravity).

Control sample K was prepared as in Sample A, except that the concentrate contained about 9 wt % SAYTEX® HP900SG stabilized hexabromocyclododecane (HBCD).

The results of the evaluation are presented in Table 1.

TABLE 1

| Sample | Description | LOI % O₂ |
|---|---|---|
| A | PS-168 with compound I | 25.8 |
| K | PS-168 with HP-900SG | 26.1 |

The results indicate that the N,2-3-dibromopropyl-4,5-dibromohexahydrophthalimde is a highly efficacious flame retardant, comparable to commercially available HBCD.

### EXAMPLE 3

The thermal stability of N,2-3-dibromopropyl-4,5-dibromohexahydrophthalimde (“compound (I)”) used in accordance with the present invention was evaluated using the Thermal HBr Measurement Test.

First, a sample of from about 0.5 to about 1.0 g flame retardant was weighed into a three neck 50 mL round bottom flask. Teflon tubing was then attached to one of the openings in the flask. Nitrogen was fed into the flask through the Teflon tubing at a flow rate of about 0.5 SCFH. A small reflux condenser was attached to another opening on the flask. The third opening was plugged. An about 50 vol % solution of glycol in water at a temperature of about 85° C. was run through the reflux condenser. Viton tubing was attached to the top of the condenser and to a gas-scrubbing bottle. Two more bottles were attached in series to the first. All three bottles had about 90 mL of about 0.1 N NaOH solutions. After assembling the apparatus, the nitrogen was allowed to purge through the system for about 2 minutes. The round bottom flask was then placed into an oil bath at about 220° C. and the sample was heated for about 15 minutes. The flask was then removed from the oil bath and the nitrogen was allowed to purge for about 2 minutes. The contents of the three gas scrubbing bottles were transferred to a 600 mL beaker. The bottles and viton tubing were rinsed into the beaker. The contents were then acidified with about 1:1 HNO₃ and titrated with about 0.01 N AgNO₃. Samples were run in duplicate and an average of the two measurements was reported. Lower thermal HBr values are preferred for a thermally stable flame retardant in extrudable polystyrene foams or extruded polystyrene foams.

Inventive sample B was prepared as described in Example 1.

The results of the evaluation are presented in Table 2.

TABLE 2

| Sample | Description | HBr (ppm) |
|---|---|---|
| B | compound I | 2,058 |
| K | HP-900 HBCD | 50,000 |

The results of this evaluation indicate that the flame retardant described herein is thermally stable, not decomposing to release excessive amounts of thermally cleaved HBr upon heating at typical operating temperatures for use in extruded polystyrene foams.

### EXAMPLE 4

The impact of flame retardant solubility on the ability to prepare expandable polystyrene foam was determined.

Sample P was prepared from SAYTEX® BN-451 (N,N′-ethylenebis(5,6-dibromo-2,3-norbornanedicarboximide; CAS No. 52907-07-0) (“BN-451”). BN-451 is recommended primarily for use in V-2 polypropylene at low loadings (approx. 4 weight %). The styrene solubility of BN-451 is less than about 0.1 weight % at about 25° C.

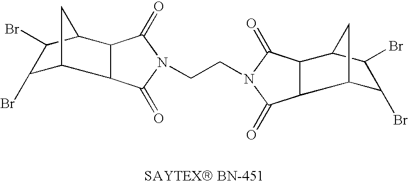

An aqueous suspension polymerization of styrene towards formation of expandable polystyrene beads was conducted as follows. About 0.28 g of polyvinyl alcohol (PVA) in 200 g of deionized water was poured into a 1-liter Büchi glass vessel. Separately, a mixture was prepared containing about 0.64 g of dibenzoyl peroxide (about 75 wt % in water), and about 2.10 g of SAYTEX® BN-451 in about 200 g of styrene. Insoluble BN-451 particles were apparent in this latter mixture, which was poured into the vessel containing the aqueous PVA solution. The liquid was mixed with an impeller-type stirrer set at about 1000 rpm in the presence of a baffle to generate shear in the reactor. The mixture was then subjected to the following heating profile: from about 20° C. to about 90° C. in about 45 minutes and held at about 90° C. for about 4.25 hours (first stage operation).

The second stage of the reaction (heat from about 90° C. to about 130° C. in about 1 hour and hold at about 130° C. for about 2 hours) was not attempted. Typically, after about 2 hours, formation of very small beads begins when a stable suspension polymerization occurs. Failure of the aqueous suspension polymerization during the first stage was observed within about 2 hours at about 90° C., evidenced by rapid increase in viscosity and formation of a large mass of polystyrene. Thus, the procedure was halted after about 2 hours heating at about 90° C. The results of this evaluation indicate that the composition of this formulation cannot be used to form fire resistant polystyrene beads. A flame retardant with higher styrene solubility is needed.

These results demonstrate that flame retardants that are recommended for use in thermoplastic resins, such as polypropylene and high impact polystyrene (HIPS), cannot necessarily be correlated to function in polystyrene foams, such as expanded polystyrene.

Surprisingly, the inventors have discovered that N,2-3-dibromopropyl-4,5-dibromohexahydrophthalimde (“compound (I)”) does have the required solubility to be effectively used in the expanded polystyrene process. The solubility of styrene is about 8 weight % at about 25° C. and about 10 weight % with gentle heat (about 40° C.).

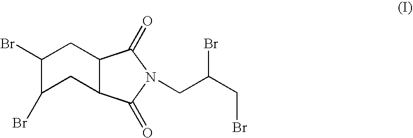

### N,2-3-Dibromopropyl-4,5-dibromohexahydrophthalimde

Expandable polystyrene beads were prepared as follows. About 0.28 g of polyvinyl alcohol (PVA) in about 200 g of deionized water was poured into a 1-liter Büchi glass vessel. Separately, a solution was formed containing about 0.64 g of dibenzoyl peroxide (about 75 wt % in water), about 0.22 g of dicumylperoxide, and about 1.68 g of FR in about 200 g of styrene. This latter solution was poured into the vessel containing the aqueous PVA solution. The liquid was mixed with an impeller-type stirrer set at about 1000 rpm in the presence of a baffle to generate shear in the reactor. The mixture was then subjected to the following heating profile: from about 20° C. to about 90° C. in about 45 minutes and held at about 90° C. for about 4.25 hours (first stage operation); from about 90° C. to about 130° C. in about 1 hour and held at about 130° C. for about 2 hours (second stage operation); and from about 130° C. to about 20° C. in 1 hour.

At the end of the first stage, the reactor was pressurized with nitrogen (about 2 bars). Once cooled, the reactor was emptied and the mixture filtered. The flame retardant beads formed in the process were dried at about 60° C. overnight and then sieved to determine bead size distribution. In this procedure, the sieves are stacked from the largest sieve size on top to the lowest sieve size on the bottom, with a catch pan underneath. The sieves are vibrated at about a 50% power setting for about 10 min., and the sieves are weighed individually (subtracting the tare weight of the sieves screens). The weight percent of material at each sieve size is calculated based on the total mass of material. An about 88.4% conversion was achieved.

Sample P is described in Example 4. Sample V was prepared similarly without the addition of a flame retardant compound. The results are presented in Table 5.

TABLE 5

| | Sample | | |
|---|---|---|---|
| | A | P | V |
| Flame retardant | compound I | BN-451 | none |
| Solubility (wt % at ˜25° C.) | ˜8.0 | <0.1 | — |
| Wt % flame retardant | 0.84 | 1.07 | 0 |
| Wt % yield | 88.4 | no yield | 91.2 |

Particle size distribution (%)

| | | | |
|---|---|---|---|
| >2 mm | 4.98 | — | 9.64 |
| From 2 mm to >1.4 mm | 33.17 | — | 50.65 |
| From 1.4 mm to >1 mm | 48.78 | — | 33.90 |
| From 1 mm to >710 μm | 8.50 | — | 3.67 |
| From 710 μm to >500 μm | 2.09 | — | 0.86 |
| From 500 μm to >250 μm | 2.49 | — | 1.28 |

The results of this evaluation indicate that the composition of the present invention can successfully be used to form flame retardant expandable polystyrene beads, which can then be used to form expanded polystyrene foams.

The foregoing description has been presented for purposes of illustration and description. It is not intended to be exhaustive or to limit the invention to the precise examples or embodiments disclosed. Obvious modifications or variations are possible in light of the above teachings. The embodiment or embodiments discussed were chosen and described to provide the best illustration of the principles of the invention and its practical application to enable one of ordinary skill in the art to utilize the invention in various aspects and with various modifications as are suited to the particular use contemplated. All such modifications and variations are within the scope of the invention as determined by the appended claims when interpreted in accordance with the breadth to which they are fairly and legally entitled.

Even though the claims hereinafter may refer to substances, components, and/or ingredients in the present tense (“comprises”, “is”, etc.), the reference is to the substance, component, or ingredient as it existed at the time just before it was first contacted, blended, or mixed with one or more other substances, components and/or ingredients, or if formed in solution, as it would exist if not formed in solution, all in accordance with the present disclosure. It does not matter that a substance, component, or ingredient may have lost its original identity through a chemical reaction or transformation during the course of such contacting, blending, mixing, or in situ formation, if conducted in accordance with this disclosure.

What is claimed is:

1. A flame-retarded expanded polystyrene foam containing a flame retardant compound having the structure:

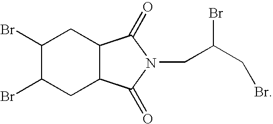

2. The expanded polystyrene foam of claim 1, wherein the flame retardant compound is present in an amount of from about 0.1 to about 10 wt % of the foam.

3. The expanded polystyrene foam of claim 1, wherein the flame retardant compound is present in an amount of from about 0.5 to about 7 wt % of the foam.

4. The expanded polystyrene foam of claim 1, wherein the flame retardant compound is present in an amount of from about 0.7 to about 5 wt % of the foam.

5. The expanded polystyrene foam of claim 1, wherein the flame retardant compound is present in an amount of from about 1 to about 2 wt % of the foam.

6. The expanded polystyrene foam of claim 1, wherein the flame retardant compound has a solubility in styrene at about 25° C. of from about 0.5 wt % to about 8 wt %.

7. The expanded polystyrene foam of claim 1, wherein the flame retardant has a solubility in styrene at about 40° C. of from about 0.5 wt % to about 10 wt %.

8. The expanded polystyrene foam of claim 1, provided as an article of manufacture.

9. The expanded polystyrene foam of claim 8, wherein the article of manufacture is thermal insulation.

10. A flame-retarded expanded polystyrene foam containing a flame retardant compound having a solubility in styrene at 25° C. of from about 0.5 wt % to about 8 wt %.

11. A composition containing from about 0.5 wt % to about 8 wt % of a flame retardant compound solubilized in styrene, the compound having the structure:

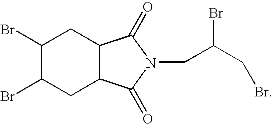

12. A method of producing flame retardant expanded polystyrene foam, the method comprising:
forming a composition comprising a flame retardant compound solubilized in styrene and a blowing agent, wherein the flame retardant compound has a solubility in styrene at 25° C. of from about 0.5 wt % to about 8 wt % and has the structure: 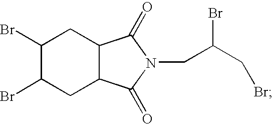
polymerizing the styrene to form polystyrene beads.

13. A process for making a molded flame retardant expanded polystyrene product, the process comprising:
pre-expanding unexpanded beads comprising polystyrene, a blowing agent, and a flame retardant compound having the structure: 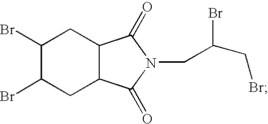
wherein the beads are substantially free of antimony trioxide; and
molding the pre-expanded beads and, optionally, further expanding the beads, to form the product.

14. The process of claim 13, wherein the product is thermal insulation.
